(19) United States
(12) Patent Application Publication
(10) Pub. No.: US 2008/0233261 A1
(43) Pub. Date: Sep. 25, 2008

(54) Fish Maw Gelatin Products And Preparation Process Thereof

(75) Inventors: Liecheng Zhang, Aojiang Town (CN); Meijun Guan, Aojiang Town (CN); Shaohua Wang, Aojiang Town (CN); Jianzhang Sun, Aojiang Town (CN)

Correspondence Address: HAMRE, SCHUMANN, MUELLER & LARSON, P.C., P.O. BOX 2902, MINNEAPOLIS, MN, 55402-0902, US

(73) Assignee: YUTIAN GROUP, Aojiang Town, Pingyang County, Zhejiang (CN)

(21) Appl. No.: 10/587,011

(22) PCT Filed: May 17, 2004
(86) PCT No.: PCT/CN2004/000489

§ 371 Date: Nov. 30, 2007

(30) Foreign Application Priority Data
Jan. 21, 2004 (JP) 200410002624.3

(51) Int. Cl. A23L 1/0562; A23L 1/00; B65D 85/00

(52) U.S. Cl. 426/576; 426/442; 426/392

(57) ABSTRACT

The present invention relates to a fish maw glue product and preparation process thereof. The product is characterized in that having tiny yellow and transparent appearance, being powdery, having moisture content of less than 10%, and particle size of 80-200 mesh. Its preparation process includes: pre-treating raw material, washing with water, preparing glue, drying, obtaining glue, pulverizing, packing under vacuum. The process is advanced, easy to handle. After people eat the product, it is easy to digest and to absorb, and has the functions of improving nutrition and nature of a drug. Said fish maw glue may further be made into slice, gel or glue liquor.

### TECHNICAL FIELD OF THE INVENTION

The invention relates to a food product and its preparation. Specifically, the invention relates to fish maw gelatin (fish isinglass) of Sciaenidae and its preparation.

### BACKGROUND OF THE INVENTION

Fish maws (fish air bladders), for example, those of the Sciaenidae such as big yellow croaker (Pseudosciaena crocea) and small yellow croaker (Pseudosciaena polyatics) and those of the Acipenser, have been conventionally processed into dried products. An early record of edible fish maw products can be traced back to in the “Chi People's Book”. The fish maw has been known as being abundant in nutrients and having some medical uses, and thus has long been taken as a valuable tonic agent.

Conventionally, fish maws of the Sciaenidae are preserved by sunning and/or drying the raw material. For consumption, the preserved products are chopped up, steamed and served with sugar. However, in such a way, the nutrients in the fish maw are poorly absorbed, particularly by old people, which turns out to be a waste of the natural source. Up till now, there has not been found any patents of products or processes in the related classification. Most previous disclosures are about the morphology, the geography and genetics of the Sciaenidae. Two articles, “The Preparation Of Fish Maw Gelatin” (Ji Shu Yu Shi Chang, 1996, 6: 13) and “The Manufacture Of Fish Maw Gelatin” (Shi Ping Ji Xie), described processes of preparing fish maw gelatin including the following steps: (1) pre-treatment of raw materials, including selecting fish maws that are brilliant yellow, dry and odor-free, and then washing the selected, soaking in water at 70° C. in a stainless-steel jacketed cooker to soften them, cooling down, chopping and milling; (2) enzymolysis, including placing the milled fish maws in a jacketed cooker, adding water at 15 times the amount of the dry fish maws and 0.4% protease, e.g., papain, mixing at 55-65° C. for about 6 hours to complete the enzymolysis; (3) filtration, including filtering through a screen of 60 mesh to remove the insoluble residues; (4) concentration and sweetening, including transferring the filtrate into a jacketed cooker of skip-bucket model, vaporizing the water by steam-heating until a syrup is obtained, and adding crystal sugar at an amount of 3% of the dry fish maws; (5) molding the syrup of concentrate in a sterilized module whose inner has been coated with a layer of edible oil; (6) drying the molded product with hot air at 60-70° C. to reduce the moisture to no more than 12 wt %; the dried product could be packaged. It can been seen that the process was complex, and most likely to cause damages to nutrients.

Therefore, it is still desired to develop an improved process of preparing fish maw gelatin that utilizes the source in an efficient way, minimizes the loss in nutrition and medicine activities, maximizes the yield, improves the absorption by a consumer, enhances the effects in nutrition and/or medication. This will be significantly valuable in improving the people's life quality and personal health.

### DESCRIPTION OF THE INVENTION

An object of the invention is to eliminate the defects in the prior arts as said above by providing a new fish maw gelatin product and its preparation.

In a first aspect, the invention provides a fish maw gelatin product that is transparent and slightly yellowish, which can be further processed into a powder having a particle size of 80-200 mesh, and has a moisture content below 10 wt %. The product can be packaged.

In a second aspect, the invention provides a process of preparing a fish maw gelatin product. The process includes the following steps: soaking softened and optionally chopped fish maws in an acid and treating with the acid at 10-15° C.; after washing with water, effecting gelatinizing by subjecting the fish maws to a pressure of 0.3-1 kg/cm² and a temperature of 90-120° C.; filtering the resultant gel liquor; and drying the filtrate.

The acid treatment may be carried out at about pH 3.0-4.0 for a time of about 8-48 hours. There is no limitation on selection of the acid. The appropriate acid and its concentration can readily be determined by a technician with common knowledge and normal skills in the art. The duration may vary as appropriate, which will be obvious to a technician in the art.

The washing step may be carried by rinsing the material with a water stream until pH rises to about 6-7. As an effort to maximize the yield, the step of gelatinization may be repeated by recycling the residue separated from the gel liquor to under the said temperature and pressure. Typically, the gelatinization may be repeated for 2 to 5 times, more typically, 3 times. The extraction may be carried out for a time that varies as appropriate, for example, between 20 minutes to 2 hours. The resultant gel liquor may be filtered through a stainless steel screen of 100 mesh. The drying step may be carried out at about 50±3° C. The dried fish maw gelatin product contains moisture no more than 12 wt %, preferably, no more than 10 wt %.

The dried fish maw gelatin product may be further processed by, for example, pulverizing it into a powder having a particle size of about 80-200 mesh and vacuum packaging the powder.

In one embodiment of the invention, a fish maw gelatin product is prepared by a process including the following steps: (1) pre-treatment of raw materials, including selecting fish maws that are dry and odor-free, removing impurities, washing, soaking and softening for 24 hours, cutting into pieces, and soaking in an acid at pH 3-3.5 under 10-15° C.; (2) wash, including rinsing the pre-treated materials with a water stream until pH rises to 6-7; (3) gelatinization, including placing the washed fish maws into a stainless steel jacketed pressure cooker, adding water into the cooker, applying a pressure of 0.5 Kg/cm² and a temperature of 110° C., treating for 0.5 hour, reducing the pressure and recovering the resultant gel liquor, filtering the gel liquor through a stainless steel screen of 100 mesh, recovering the filtrate, adding water into the residue and repeating the gelatinization as above for 3 times; (4) desiccation, including pouring aliquots of the filtrate into dry stainless steel plates, placing the plates in an hot air oven set at 50±3° C.; (5) recovery of gelatin, including recovering the gelatin as transparent and slightly yellowish flakes after the gel liquor filtrate is dried to a moisture content below 10 wt %; (6) pulverization, including braking the flakes with a hammer crasher into a powder sizing 80-200 mesh; (7) package, including vacuum packaging the fish maw gelatin powder after it passes the quality control.

In the step of pre-treatment, the fish maw is soaked in diluted hydrochloric acid, for example, a 0.5-1% hydrochloric acid solution.

The advantages of the invention include for example the following: it minimizes the loss of nutrients and medicine actives in the fish maws; the product of the invention in form of powder facilitates absorption by the consumer and enhances the desirable effects in nutrition and medication; the fish maw gelatin powder of the invention can readily be further processed into products in other forms such as flakes, jelly or gel liquor; the powder product of the invention facilitates the package and transportation. Further, the process of the invention is less complex and more efficient than the prior art.

The present invention will be further illustrated by the following example. However, it should be understood that the specific example is given by way of illustration only. The scope of the invention shall be defined by the claims hereinafter.

### EXAMPLE

This example produces a product of fish maw gelatin that is transparent and slightly yellowish, which is further pulverized into a powder having a particle size of 80-200 mesh, and has a moisture less than 10 wt %. The product can be vacuum packaged, and provided in form of air-tight pouches. The fish maw gelatin powder of the invention can be further processed into products in form of flakes, jelly and gel liquor.

The product is prepared by the process include the following steps: (1) pre-treatment of raw materials, including selecting fish maws that are dry and odor-free, removing the impurities, washing, soaking and softening by for 24 hours, cutting into pieces, and soaking the pieces in a diluted hydrochloric acid solution at pH 3-3.5 under 10-15° C.; (2) wash, including rinsing the acid-treated pieces with water until pH rises to 6-7; (3) gelatinization, including placing the washed fish maws into a stainless steel jacketed cooker, adding water into the cooker, applying a pressure of 0.5 Kg/cm² and a temperature of 110° C. inside the cooker for 0.5 hour, reducing the pressure and recovering the resultant gel liquor, filtering the gel liquor through a stainless steel screen of 100 mesh, recovering the filtrate, adding water into the residue and repeating the gelatinization as above for 3 times; (4) desiccation, including pouring aliquots of the filtrate into dry stainless steel plates, placing the plates in an hot air oven set at 50±3° C.; (5) recovery of gelatin, including recovering the gelatin as transparent and slightly yellowish flakes after the gel liquor filtrate is dried to a moisture content below 10 wt %; (6) pulverization, including braking the flakes with a hammer crasher into a powder sizing 80-200 mesh. After passing the quality control, the fish maw gelatin powder is packaged. Preferably, vacuum packaging will increase the shelf-life of the product. The finished products may be in any form desirable with the consumer. For example, it may be particularly desirable to provide the finished product in form of vacuum packaged small pouches.

What is claimed:

1. A fish maw gelatin product, characterized in being transparent and slightly yellowish, being in form of a powder, having a moisture content below 10 wt %, and having a particle size of 80-200 mesh.

2. A process of preparing the fish maw gelatin product according to claim 1, including: soaking softened and optionally cut up fish maws in an acid, and treating said fish maws with the acid at a temperature of 10-15° C.; washing the treated fish maws, effecting gelatinization by subjecting the washed fish maws to a pressure of 0.3-1 kg/cm² and a temperature of 90-120° C.; filtering the resultant gel liquor; and drying the filtrate to give a dried product.

3. The method according to claim 2, further including pulverizing the dried fish maw gelatin product into a powder sizing 80-200 mesh.

4. The method according to claim 2, including: (1) pre-treatment of raw materials, including selecting fish maws that are dry and odor-free, removing impurities, washing, softening by soaking for 24 hours, then bringing pH to 3-3.5 and temperature to 10-15° C.; (2) wash, including rinsing the pre-treated materials with a water stream until pH rises to 6-7; (3) gelatinization, including placing the washed fish maws into a stainless steel jacketed pressure cooker, adding water into the cooker, applying a pressure of 0.5 Kg/cm² and a temperature of 110° C. for 0.5 hour, reducing the pressure and recovering the resultant gel liquor, filtering the gel liquor through a stainless steel screen of 100 mesh, recovering the filtrate, adding water into the residue and repeating the gelatinization as above for 3 times; (4) desiccation, including pouring aliquots of the filtrate into dry stainless steel plates, placing the plates in a hot air oven set at 50±3° C.; (5) recovery of gelatin, including recovering the gelatin as slightly yellowish and transparent flakes after the gel liquor is dried to a moisture content below 10 wt %; (6) pulverization, including braking the flakes with a hammer crasher into a powder sizing 80-200 mesh; (7) package, including vacuum packaging the fish maw gelatin powder after it passes the quality control.

5. The method according to claim 2, wherein said acid is hydrochloric acid.
